(19) United States
(12) Patent Application Publication
(10) Pub. No.: US 2017/0023211 A1
(43) Pub. Date: Jan. 26, 2017

(54) FLEXIBLE UNOBSTRUCTED BEAM SHAPING

(71) Applicant: PHILIPS LIGHTING HOLDING B.V., Eindhoven (NL)

(72) Inventors: Ruslan Akhmedovich SEPKHANOV, EINDHOVEN (NL); Marcellinus Petrus Carolus Michael KRIJN, EINDHOVEN (NL); Wilhelmus Petrus Adrianus Johannus MICHIELS, EINDHOVEN (NL)

(73) Assignee: PHILIPS LIGHTING HOLDING B.V., Eindhoven (NL)

(21) Appl. No.: 15/039,356

(22) PCT Filed: Nov. 3, 2014
(86) PCT No.: PCT/EP2014/073531

§ 371 Date: May 26, 2016

(30) Foreign Application Priority Data
Dec. 16, 2013 (EP) 13197338.0

(51) Int. Cl. F21V 13/04; F21V 7/10

(52) U.S. Cl. CPC F21V 13/04; F21V 7/10; F21S 8/088

(57) ABSTRACT

The invention provides a lighting device (100) comprising a reflector (110) and a light source (120) configured to provide in the absence of an optical plate (130) a beam (2) of lighting device light (101) with an original optical axis (102) and an original opening angle (θ), wherein the lighting device (100) comprises said optical plate (130) configured within the reflector (110), wherein the optical plate comprises a light transmissive layer (131) comprising micro optical structures (132), and wherein the lighting device (100) including the optical plate (130) is configured to provide said beam (2) of lighting device light (101) having one or more of (i) a final opening angle (θf) with θf>θ, and (ii) a final optical axis (102f) having a non-zero angle (β) with the original optical axis (102).

### FIELD OF THE INVENTION

The invention relates to a lighting device comprising a reflector, as well as to a method for changing the optical properties of such lighting device. Further, the invention also relates to a specific use of an optical element (for such lighting device).

### BACKGROUND OF THE INVENTION

Street lighting and the optical design thereof has been described in a plurality of patent applications and patents. US2007201225, for instance, describes an apparatus and method characterized by providing an optical transfer function between a predetermined illuminated surface pattern, such as a street light pattern, and a predetermined energy distribution pattern of a light source, such as that from an LED. A lens is formed having a shape defined by the optical transfer function. The optical transfer function is derived by generating an energy distribution pattern using the predetermined energy distribution pattern of the light source. Then the projection of the energy distribution pattern onto the illuminated surface is generated. The projection is then compared to the predetermined illuminated surface pattern to determine if it acceptably matches. The process continues reiteratively until an acceptable match is achieved. Alternatively, the lens shape is numerically or analytically determined by a functional relationship between the shape and the predetermined illuminated surface pattern and predetermined energy distribution pattern of a light source as inputs.

### SUMMARY OF THE INVENTION

In many optical applications a lighting unit is required to provide different light beam profiles while having the same or at least a very similar visual appearance of the unit and keeping the architecture of the unit untouched as much as possible, thus allowing for late-stage configuration. Beam shaping includes alteration of angular and/or spatial distribution of the light and is performed by regular optical elements, such as reflectors, lenses, prisms and mirrors.

Hence, it is an aspect of the invention to provide an alternative lighting device, which preferably further at least partly obviates one or more of above-described drawbacks, and which may especially allow late-stage adaption of the optical properties of the lighting device. It is further an aspect of the invention to provide a method of changing the optical properties of an (existing) lighting device, which preferably further at least partly obviates one or more of above-described drawbacks, and which may especially allow late-stage adaption of the optical properties of the lighting device. Since the reflector of the unit defines to a large extent the appearance of the unit, it is preferred to alter the light beam by means of additional optical elements (while especially keeping the overall appearance and dimensions of the reflector unit the same, thereby allowing the use of the reflector unit in the same lamp, but with different optical properties).

In a first aspect, the invention provides a lighting device comprising a reflector with a reflector wall and a reflector opening and a light source configured to provide in the absence of an optical plate a beam of lighting device light with an original optical axis and an original opening angle (θ), wherein the lighting device comprises only one optical plate, wherein the optical plate comprises a light transmissive layer comprising micro optical structures, and wherein the lighting device including the optical plate is configured to provide said beam of lighting device light (downstream of said optical plate) having one or more of (i) a final opening angle (θf) with θf>θ, and (ii) a final optical axis having a non-zero angle (β) with the original optical axis, the reflector widens from the light source to the reflector opening and has a length L, the optical plate being mounted within the reflector (110) to the reflector wall (111) in between 5% to 95% of the length L.

Hence, in a specific embodiment the invention provides a lighting device comprising a reflector with a reflector wall and a reflector opening and a light source configured to provide in the absence of an optical plate a beam of lighting device light with an original optical axis and an original opening angle (θ), wherein the lighting device comprises only one optical plate, wherein the optical plate comprises a light transmissive layer comprising micro optical structures, and wherein the lighting device including the optical plate is configured to provide said beam (i.e. final beam) of lighting device light (downstream of said optical plate) having a final opening angle (θf) with θf>θ, the reflector widens from the light source to the reflector opening and has a length L, the optical plate being mounted within the reflector (110) to the reflector wall (111) in between 5% to 95% of the length L. However, in yet another aspect, the invention also provides a lighting device comprising a reflector with a reflector wall and a reflector opening and a light source configured to provide in the absence of an optical plate a beam of lighting device light with an original optical axis and an original opening angle (θ), wherein the lighting device comprises only one optical plate, wherein the optical plate comprises a light transmissive layer comprising micro optical structures, and wherein the lighting device including the optical plate is configured to provide said beam (i.e. final beam) of lighting device light (downstream of said optical plate) having a final opening angle (θf) with θf=θ or θf<θ, the reflector widens from the light source to the reflector opening and has a length L, the optical plate being mounted within the reflector (110) to the reflector wall (111) in between 5% to 95% of the length L.

Hence, in a further specific embodiment the invention also provides a lighting device comprising a reflector with a reflector wall and a reflector opening and a light source configured to provide in the absence of an optical plate a beam of lighting device light with an original optical axis (see also below) and an original opening angle (θ), wherein the lighting device comprises only one optical plate, wherein the optical plate comprises a light transmissive layer comprising micro optical structures, and wherein the lighting device including the optical plate is configured to provide said beam (i.e. final beam) of lighting device light (downstream of said optical plate) having a final optical axis having a non-zero angle (β) with the original optical axis, the reflector widens from the light source to the reflector opening and has a length L, the optical plate being mounted within the reflector (110) to the reflector wall (111) in between 5% to 95% of the length L.

In yet a further aspect, the invention provides a method of changing the optical properties of an (existing) lighting device, wherein the (existing) lighting device comprises a reflector with a reflector wall and a reflector opening and a light source, the reflector having a length L between the reflector opening and the light source and being configured to provide in the absence of an optical plate a beam of lighting device light with an original optical axis and an original opening angle (θ), the method comprising arranging only one optical plate to the reflector wall in the reflector in between 5% to 95% of length L downstream of the light source wherein the optical plate comprises a light transmissive layer comprising micro optical structures, and wherein the optical plate is configured to provide said beam of lighting device light (downstream of said optical plate) with one or more of (i) a final opening angle (θf) with θf>θ, and (ii) a final optical axis having a non-zero angle (β) with the original optical axis.

Hence, in a specific embodiment (of the method) the invention also provides a method of changing the optical properties of an (existing) lighting device, wherein the (existing) lighting device comprises a reflector with a reflector wall and a reflector opening and a light source, the reflector having a length L between the reflector opening and the light source and being configured to provide in the absence of an optical plate a beam of lighting device light with an original optical axis and an original opening angle (θ), the method comprising arranging only one optical plate to the reflector wall in the reflector in between 5% to 95% of length L downstream of the light source wherein the optical plate comprises a light transmissive layer comprising micro optical structures, and wherein the optical plate is configured to provide said beam (i.e. final beam) of lighting device light (downstream of said optical plate) with a final opening angle (θf) with θf>θ.

Hence, in a further specific embodiment (of the method) the invention also provides a method for changing the optical properties of an (existing) lighting device, wherein the (existing) lighting device comprises a reflector with a reflector wall and a reflector opening and a light source, the reflector having a length L between the reflector opening and the light source and being configured to provide in the absence of an optical plate a beam of lighting device light with an original optical axis and an original opening angle (θ), the method comprising arranging only one optical plate to the reflector wall in the reflector in between 5% to 95% of length L downstream of the light source wherein the optical plate comprises a light transmissive layer comprising micro optical structures, and wherein the optical plate is configured to provide said beam (i.e. final beam) of lighting device light (downstream of said optical plate) having a final optical axis having a non-zero angle (β) with the original optical axis.

With the present invention it may be possible to keep the appearance of the lighting device, which may be mostly defined by the reflector (or reflector unit), the same while the beam shape and/or direction may be changed at a late stage, even when the lighting unit is already in its installed state (e.g. arranged in a street lamp or a stadium lamp, etc.). Hence, the present invention facilitates the desire to change the beam profile of an (existing) lighting device without the need to change the reflector. Therefore, in a relative easy way existing lighting units may be adapted to comply with the current desire of users, such as street users, without the need to design a new production line. Further, it allows the use of relative easily made application designed foils with optical elements.

Especially, such lighting device may be used to illuminate indoor areas and/or outdoor areas. One may consider e.g. illuminating a surface in the home, a hospitality (area), an industry office, or an outdoor environment. Such surface can be especially a ceiling or wall, or floor, or ground, of e.g. a hotel lobby, an arena, a stadium, an opera, cinema, etc., or a road, a square, etc. One may also consider e.g. illuminating a surface, such as especially, an open place, a runway, an airstrip and a built-on area. Herein, the term “road” especially relates to paved roads which are designed for transport of motorized vehicles such as cars, automobiles, trucks, or motors. Herein the terms “runway” or “airstrip” especially relates to paved roads which are designed for take-off and/or landing of airplanes or aircrafts.

The lighting device may comprise one or more light sources. The one or more light sources may (at least partially) be comprised by a single reflector (reflector unit). However, a single reflector may also comprise a plurality of light sources. Hence, in an embodiment the lighting device comprises a plurality of light sources. In yet another embodiment, the lighting device comprises a plurality of reflectors, with each reflector comprising one or more light sources.

The phrase “reflector comprising a light source” and similar phrases especially indicated that the reflector at least partly encloses the light source. For instance, a light emitting diode (LED) may be within the reflector, such that the reflector reflects at least partly the light emitted by the LED. The reflector may be e.g. a parabolic reflector, an elliptical reflector, a total internal reflector collimator, a compound parabolic concentrator (CPC) reflector, or a free-shape reflector, etc. In a specific embodiment, the reflector is a specular reflector. The original function of the reflector may be to collimate the light of the light source in a beam. Hence, the term “reflector” may also refer to a “collimator”.

In an embodiment, the invention also relates to a reflector enclosing a (smaller) collimator, wherein the collimator comprises the light source (or optionally a plurality of light sources). Optionally, such reflector may enclose a plurality of collimators. Likewise, the invention also relates to a reflector enclosing a smaller reflector (such as a collimator or CPC, etc.), wherein the smaller reflector comprises the light source (or optionally a plurality of light sources).

The (original) beam can be a substantially collimated beam, but this beam may also be a diverging beam (i.e. original opening angle θ>0°). The beam divergence may however be smaller than without such reflector (and without the optical plate; see below). Hence, in principal conventional light source reflector units (herein also indicated as “reflector unit”) may be used. In such conventional light source reflector units the optical plate may be arranged, e.g. by gluing or sticking or pinching the optical plate. However, in yet other specific embodiments, the reflector may be adapted (already during the production of the reflector) to host the optical plate (see below). The combination of reflector and light source is herein also indicated as “reflector-light source unit”.

In a specific embodiment, the light source comprises a solid state light source (such as an LED or a laser diode). As indicated above, the term “light source” may also relate to a plurality of light sources, such as 2-20 (solid state) LED light sources. Hence, the term LED may also refer to a plurality of LEDs.

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL.

In case the lighting device comprises a plurality of light sources and/or a plurality of reflector-light source units (i.e. especially a combination of a reflector and one or more light sources at least partially enclosed by the reflector), the light sources and/or reflector-light source units may optionally individually be controllable. Hence, in an embodiment, the lighting device further comprises a control unit configured to control one or more optical properties of the light source or plurality of light sources (in case the lighting device comprises a plurality of light sources).

The (original) beam generated by the combination of the light source and reflector has an optical axis and opening angle. The term “optical axis” is known in the art and in general indicates an imaginary line that defines the path along which light propagates through (or from) the system, i.e. here the reflector (and downstream of the reflector opening). In case of a substantially collimated beam the opening angle is substantially 0°. The term “opening angle” is known in the art, and may especially define the angle defining the width that light emits from a light source, more especially the angle between the opposing points relative to the beam axis or optical axis where the intensity drops to 50% of its maximum. The intensity is the luminous intensity and may especially be measured in candelas (cd).

Without the optical plate, the (original) beam generated by the light source would have above defined opening angle, also indicated as original opening angle, and optical axis, also indicated as original optical axis. This does not exclude further optical elements downstream of the reflector, which may have further impact on the beam and beam direction. These further optical elements are not specific part of the invention. However, in general these are especially transparent and not scattering.

Hence, the term “final beam” and other terms with “final”, merely indicates the beam, etc. (directly) downstream of the optical plate, and does not exclude further changes of the optical properties of the (final) beam with a further optical element downstream of said optical plate.

In the invention however, an optical element, indicated as optical plate, is arranged inside the reflector. This optical plate is especially configured to modify one or more of the direction of the optical axis and the beam width (opening angle). The optical plate is a transmissive optical element, i.e. an element comprising a solid or liquid material, especially solid material that is transmissive, especially transparent for the light generated by the light source. This material is indicated as “transmissive material” or “material”.

The transmissive material may comprises one or more materials selected from the group consisting of a transmissive organic material support, such as selected from the group consisting of PE (polyethylene), PP (polypropylene), PEN (polyethylene naphthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), (PETG) (glycol modified polyethylene terephthalate), PDMS (polydimethylsiloxane), and COC (cyclo olefin copolymer). However, other (co)polymers may also be possible. Especially preferred are PMMA or PC.

Especially, the material, even more especially the optical plate, has a light transmission in the range of 70-100%, especially at least 90%, such as in the range of 90-100%, for light generated by the light source and having a wavelength selected from the visible wavelength range. In this way, the optical plate is transmissive for visible light from the light source. Herein, the term “visible light” especially relates to light having a wavelength selected from the range of 380-780 nm.

The transmission can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

As indicated above, this optical plate leads to deviation of one or more of the optical axis and the opening angle of the beam of the original optical axis and beam angle, respectively. Hence, downstream of the optical plate, the lighting device provides a beam having a final optical axis and a final opening angle, of which one or more may differ from the original. In this way, in a late stage the beam properties may be adapted in a relatively easy way.

The optical plate comprises micro optical structures. These micro optical structures may especially comprise one or more of prismatic elements, lenses, total internal reflection (TIR) elements, refractive elements, facetted elements. Optionally, a subset of elements may be translucent or scattering (see also below). In general, at least a subset or all of the micro optical structures are transparent. The micro optical structures may be embedded in the optical plate, and may especially be part of an optical plate side (or face), such as especially a downstream side or an upstream side, or both the downstream and upstream side. Herein, the micro optical structures are especially further described in relation to micro optical structures having a Fresnel or refractive function and micro optical structures having a total internal reflection function. Each micro optical structure may comprise one or more facets. Fresnel lenses may e.g. be utilized to collect and precollimate the light of the light sources, especially the LEDs. The beam can be tilted by shifting the Fresnel lens with respect to the sources and/or by adding some prismatic structures. These are two different ways, which may be used alternatively or additionally. A Fresnel lens can also be a free shape lens performing some more complex optical operations on the beam.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

The facets may be arranged at an upstream side or a downstream side or both the upstream side and downstream side of the optical plate (first and/or second optical plate, etc.). Especially, TIR elements are especially available at an upstream side of the optical plate (first and/or second optical plate), whereas the refractive elements, such as Fresnel lenses, may be arranged at the upstream and/or downstream side of the optical plate (first and/or second optical plate). The dimensions of the facets (of these elements), especially of the TIR elements, like height, width, length, etc., may in embodiments be equal to or below 5 mm, especially in the range of 0.001-5 mm, like 0.01-5 mm, such as below 2 mm, like below 1.5 mm, especially in the range of 0.01-1 mm. Hence, the micro optical structures have a dimension, like height, width, length, etc., in the range of 0.001-5 mm, such as 0.005-5 mm. The diameters of the refractive Fresnel lenses may in embodiments be in the range of 0.02-50 mm, such as 0.5-40 mm, like 1-30 mm, though less than 30 mm may thus (also) be possible, like equal to or smaller than 5 mm, such as 0.1-5 mm. The height of these facets will also in embodiments be below 5 mm, such as below 2 mm, like below 1.5 mm, especially in the range of 0.01-1 mm. Here the term “facet”, especially in TIR embodiments, may refer to a (substantially) flat (small) faces, whereas the term “facet”, especially in Fresnel embodiments, may refer to curved faces. Thus curvature may especially be in the plane of the optical plate, but also perpendicular to the plane of the optical plate (“lens”). The Fresnel lenses are not necessarily round, they may also have distorted round shapes or other shapes.

Hence, the optical plate comprises a foil comprising a plurality of micro optical structures selected of one or more of a Fresnel lens, a prismatic structure, and a facet. For instance, the micro optical structures may include total internal reflective (TIR) elements. Especially, the lighting device may (at least) comprise a plurality of Fresnel lenses. Further, in an embodiment the optical plate comprises a plurality of micro optical structures at an upstream face (132a) and a plurality of micro optical structures at a downstream face (132b). In yet a further embodiment, the optical plate comprises a plurality of regions, wherein the lighting device including the optical plate with the plurality of regions is configured to provide a plurality of beams (i.e. final beams). Hence, in such a system the optical plate may create a plurality of beams from an original single beam.

The optical plate may be embodied as a foil or film provided on a plate, etc. The optical plate may also have a 3D shape. Especially, the optical plate is arranged perpendicular to the original optical axis or perpendicular to the light rays of the light source (in case of 3D shape) and especially extends to the reflector wall (i.e. no light source light may leak away). Such 3D shaped optical element may e.g. be a curved optical plate, like a hemispherical shaped optical plate, etc. For instance, when using a foil, such foil can especially be designed for the desired application. Hence, for instance micro optical foils may be used.

The optical plate may perform a collimating and/or a tilting function, such that the tilted partial beams add up creating the final beam (see FIG. 2f). The final beam is broader than the original beam, that is, the beam of reflector and the sources without the optical plate. The collimating and the tilting of these partial beams may be performed by Fresnel lenses, especially by Fresnel lenses combined with TIR optical elements.

The optical plate may perform a collimating and a tilting function, such that the tilted partial beams all have the same direction and opening angle. This opening angle is then the opening angle of the final beam (see FIG. 2a, 2b or 2c). The collimating and the tilting of these partial beams may be performed by Fresnel lenses, especially by Fresnel lenses combined with TIR optical elements, and by prismatic structures.

The change in the optical axis may be any change desired. In general, however, the change in angle may be in the range of up to 80° (i.e. 0°<β≦80°.) Further, with the optical plate, the beam width may be tuned. The final opening angle θf may be larger than the original opening angle θ. However, the final opening angle θf may also be smaller than the original opening angle θ. In general, however, the final opening angle θf will be larger than the original opening angle. For instance, 0°<θf−θ<180°, such as 0°<θf−θ≦120°.

Beam direction change is beneficial, for instance, in street lighting when the lighting unit is located above the pedestrian area. Such location of the lighting unit saves installation and maintenance costs, because the road does not have to be closed for automobile traffic during these operations. The tilted beam prevents the light from entering residential windows that are usually close to the pedestrian area. Late stage customization by means of the optical plate allows thus to use almost the same lighting unit (produced at the same production line) to be placed above pedestrian areas with residential windows next to it and above the traffic areas when necessary. Making the beam broader or narrower allows for placing the luminaire higher or lower, respectively. This may be beneficial when such placing is mechanically preferred. Furthermore, making the beam broader extends the application area of the lighting unit. Generally, this late stage customization grants additional freedom of application of the same appearing lighting unit.

In specific embodiment, both the direction of the optical axis and the beam opening angle may be changed (at a late stage). Hence, in a specific embodiment, the invention also provides a lighting device comprising a reflector with a reflector wall (111) and a reflector opening (RO) and a light source configured to provide in the absence of an optical plate a beam of lighting device light with an original optical axis and an original opening angle (θ), wherein the lighting device comprises only one optical plate, wherein the optical plate comprises a light transmissive layer comprising micro optical structures, and wherein the lighting device including the optical plate is configured to provide said beam of lighting device light having one or more of (i) a final opening angle (θf) with θf>θ and (ii) a final optical axis having a non-zero angle (β) with the original optical axis, the reflector widens from the light source to the reflector opening and has a length L, the optical plate being mounted within the reflector (110) to the reflector wall (111) in between 5% to 95% of the length L. Further, the invention also provides (in this respect) a method for changing the optical properties of an (existing) lighting device, wherein the (existing) lighting device comprises a reflector with a reflector wall (111) and a reflector opening (RO) and a light source, the reflector having a length L between the reflector opening and the light source and being configured to provide in the absence of an optical plate a beam of lighting device light with an original optical axis and an original opening angle (θ), the method comprising arranging only one optical plate to the reflector wall in the reflector in between 5% to 95% of length L downstream of the light source wherein the optical plate comprises a light transmissive layer comprising micro optical structures, and wherein the optical plate is configured to provide said beam of lighting device light having one or more of (i) a final opening angle (θf) with θf>θ and (ii) a final optical axis having a non-zero angle (β) with the original optical axis.

With the present invention, it is also possible to direct the light downstream of the optical plate in such a way, that it does not hit or does not substantially hit the reflector wall. Hence, the final light beam may substantially be unobstructed by the reflector. Hence, in a specific embodiment the optical plate is configured to direct the beam of light away from a reflector wall downstream of the optical plate. In this way, the light beam downstream of the optical plate may not hit the reflector.

The optical plate may be arranged inside the reflector in several ways. The optical plate may be clamped, attached, glued, etc. in the reflector. Especially, the reflector may include an element, especially obtained during production of the reflector that facilitates (a later) hosting of the optical plate in the reflector. This may especially be a (slight) discontinuity (such as a (small) edge or a (small) ledge or other support feature). Hence, in a specific embodiment the reflector comprises a reflector wall having light reflective properties, and wherein the reflector wall comprises a (small) discontinuity configured to host the optical plate. Alternatively or additionally, the optical plate is releasably attached to the reflector wall, for instance with Velcro, clamps, a glue or other adhesive. Especially, this may be an optical adhesive (i.e. transmissive for visible light). Thus customization of the already installed lighting device to provide the desired lighting conditions by means of the exchange of the optical plate is enabled.

From a top of the light source(s) to the reflector opening, the reflector will have a length. The optical plate in general is arranged somewhere in between 5-95% of this length, such as 5-80% if this length, such as 10-70%. Especially, the optical plate may be closer to the light sources(s) than to the reflector opening (5% means relative close to the light source(s). however, the optical plate may also be closer to the reflector opening than to light source(s). When a smaller reflector is arranged in a larger reflector, the length is the length from the light source to the reflector opening of the larger reflector. In general, the light source or plurality of light sources will be arranged at one end of the reflector, and the reflector opening, from which the light source light (after passing the optical plate) escapes from the reflector.

As indicated, the optical plate may be arranged in a so-called late stage. The lighting device may then be installed, or not yet installed, but may especially at least have left the production line. Hence, in an embodiment the lighting device is an (existing) lighting device wherein the (existing) lighting device is in a pre-installed state. In yet another embodiment, the (existing) lighting device is in an installed state. The term “existing” is used to indicated that in principle the lighting device is ready and can be used per se, and not still on a production line. In a specific embodiment, the lighting device is comprised by a street lamp. Hence, the invention provides the use of only one optical plate comprising a light transmissive layer comprising micro optical structures in a reflector of an (existing) lighting device comprising said reflector and a light source for late-stage adaptation of optical properties of a beam of lighting device light generated by said lighting device during use.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some aspects of the herein described device and application;

FIGS. 2a-2g schematically depict some embodiments of the invention and variants not part of the invention of the therein described device and application; and

FIG. 3 schematically depicts a specific application.

The drawings are not necessarily on scale.

### DETAILED DESCRIPTION OF THE EMBODIMENTS

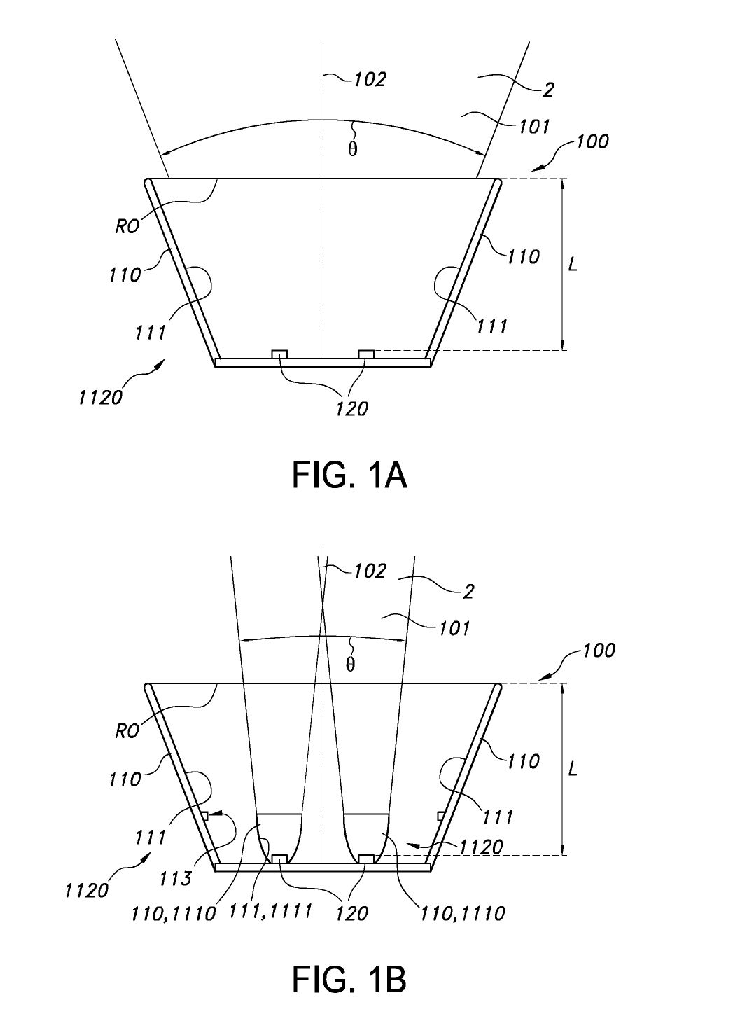

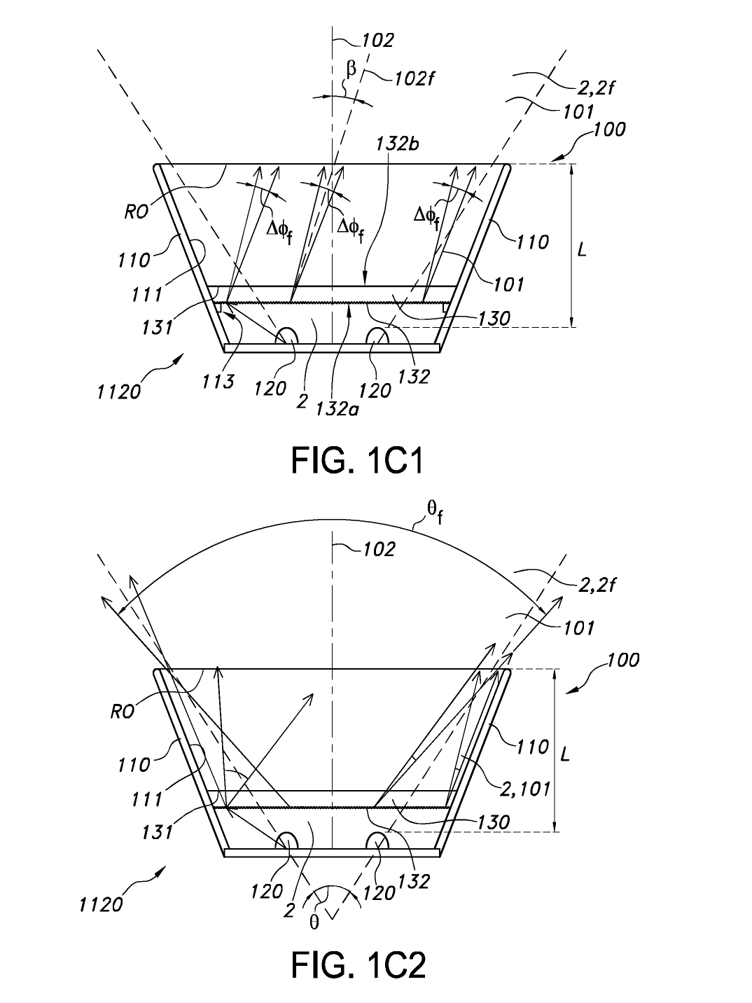

FIGS. 1a and 1b schematically depict some basic variants of a lighting device 100, yet without (additional) optical plate. The lighting device 100 comprises a reflector 110 with reflector wall 111 and one or more light sources 120. Here, by way of example two light sources 120 are depicted, which are by way of example arranged within the reflector. The reflector has a reflective reflector wall, by which light 101 of the light source(s) 120 is collimated in a beam 2 with an optical axis 102. The opening angle of the beam is indicated with reference θ. FIG. 1b schematically depicts an alternative version, wherein a combination of reflector and light source is at least partly arranged in the reflector 110. Here, the small reflector comprises collimating optics, such as a total internal reflection collimator or Compound Parabolic Concentrating (CPC) collimator. This collimating optics is indicated with reference 1110, but is in fact also a reflector. Hence, the collimation optics is also indicated as reflector 110. In this embodiment, the larger reflector 110 may comprise or at least partially enclose one or more smaller reflectors 110. In this smaller reflector, here indicated as collimating optics 1110, the light source(s) 120 may be arranged. The reflector opening of the larger reflector is indicated as RO. The smaller reflector also has a reflector opening (not indicated in the drawings). Further, both the larger reflector and the smaller reflector have reflector walls 111. For the smaller reflector, here the collimating optics 1110, this wall is also indicated as collimating optics wall, which is indicated with reference 1111. Reference 1120 indicates a reflector-light source unit, which includes the reflector 110 and a light source 120 (or a plurality of light sources 120) (comprised by the reflector 110). FIG. 1b is a very schematic drawing. In general the beam 2 will be at least partly also be defined by the (larger) reflector 110, in general even be mostly defined by this (larger) reflector 110 (and thus not only by the smaller reflector or collimating optics 1110.

Downstream of the reflector opening of the lighting devices as described herein, optionally one or more further optical elements may be configured. Especially these are transparent.

It often becomes clear that for certain cases/applications the beam shape has to be adjusted. This need can be due to many reasons ranging from energy saving consideration (e.g. providing less light where it is not needed and more in other places) to comfort considerations (e.g. preventing the light from getting into the residents' windows). From the design point of view it is desirable that all luminaires have the same appearance independent of the beam they provide. The beam shaping satisfying this constraint could be achieved by changing the reflective properties of the reflector 110, changing the source configuration or adding an optical element that fits within the reflector size. From the point of view of fabrication and the stock cost it is desirable to produce all the luminaires maximally standard and, thus, perform the beam shaping with a minimal hardware change having minimal to no changes in the architecture. These two restrictions suggest that the best solution in this case is an additional optical element placed inside the reflector. Now, when desired, in a late stage the properties of beam 2 may be changed. This can be done in several ways, like providing the optical plate in the main reflector 110 and/or providing the optical plate on or in the collimating optics 1110 in case these are available. A few options are described below.

From a top of the light source(s) 120 to the reflector opening RO, the reflector 110 has a length L. The optical plate in general is arranged somewhere in between 5-95% of this length L, such as 5-80% if this length, such as 10-70%. Optionally, the optical plate may be in contact with the light sources 120.

FIG. 1c schematically depicts two variants, though more variants are possible (see further below). In a first variant, FIG. 1C1 the additional optical element, i.e. the optical plate 130, may in this embodiment be a foil comprising a plurality of micro optical structures, creates the beam with beam width Δφ, herein also indicated as opening angle θ. The foil is structured on the bottom side, although it can be structured on any sides or on both sides. The foil performs the conventional beam shaping having approximately the same beam width independently on the position. This is possible because the target beam may for instance be relatively narrow so that the rays do not hit the reflector. The freedom of beam shaping at a location is determined by the angular opening of the beam that enters the optical element at that location. Therefore it is favorable to position the additional optical element such that it receives the light either from the source or from the reflector alone, instead of receiving it from both the source and the reflector. Together with the requirements that the appearance of the lighting unit has to stay unchanged, this leads to positioning of the optical element inside the reflector. The optical element has to take the presence of the reflector into account when redirecting the light, because the reflector may obstruct and therefore impair the beam shaping. In another variant, FIG. 1c2, the additional optical element, in this case by way of example also a foil comprising a plurality of micro optical structures creates a tilted wide beam. The foil is structured on the bottom side, although it can be structured on any sides or on both sides. The conventional beam shaping fails because the beam is broad enough for the rays to scatter from the reflector. Therefore an optimized unobstructed beam shaping is performed by the optical element. The beam directions and angular opening vary as a function of the position on the optical element such that they together construct the target beam. Reference 131 indicates the transmissive layer comprising the micro optical elements. The micro optical elements are indicated with reference 132. Note that a wider and a narrower beam than without optical plate can be provided and/or that a beam with the same or another direction (optical axis) may be provided.

To distinguish between the beam 2 upstream of the optical plate 130 and the beam 2 downstream of the optical element, the latter is also indicated as final beam 2f. Hence, downstream of the optical plate, the beam is indicated with reference 2, and the beam may substantially have an opening angle θ and an optical axis 102; downstream of the optical plate, the beam may be indicated with reference 2f, may have an opening angle θf, and an optical axis 102f. The original beam 2 which could e.g. have been produced without the optical plate 130 is only by way of example—also indicated with the dashed lines at the edges of the reflector.

As can be seen in e.g. FIGS. 1c1 and 1c2, it is possible to guide the light source light away from the reflector wall. Hence, without (substantially) hitting the reflector wall, the beam direction and or opening angle can be changed. Even the opening angle can be enlarged without hitting the reflector wall. Hence, a flexible unobstructed beam shaping device is herein provided.

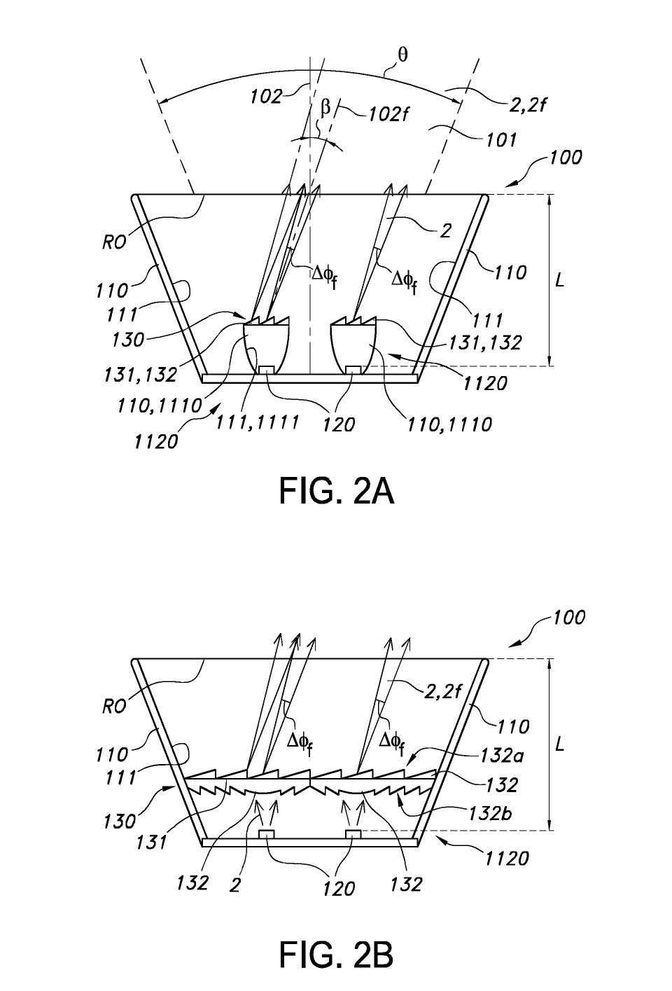

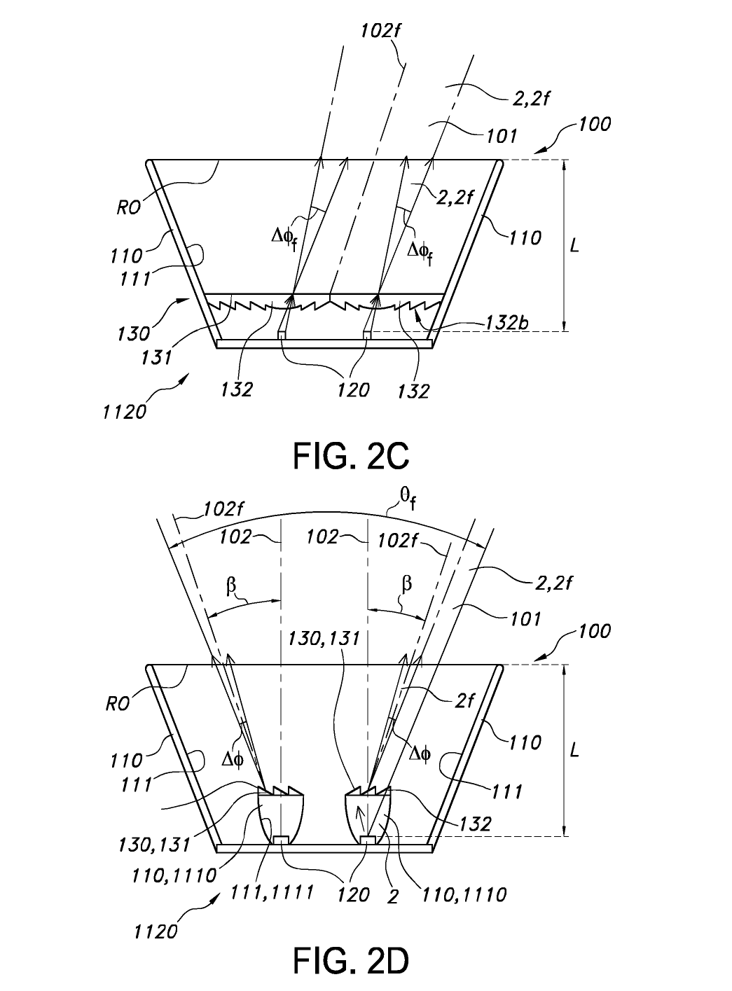

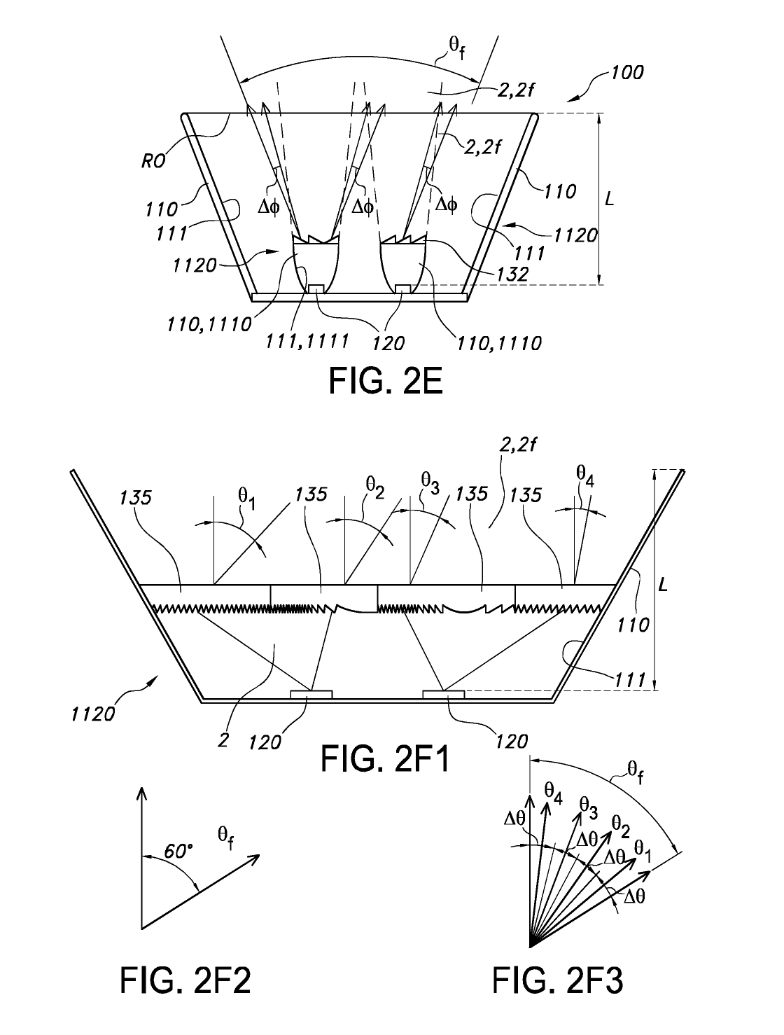

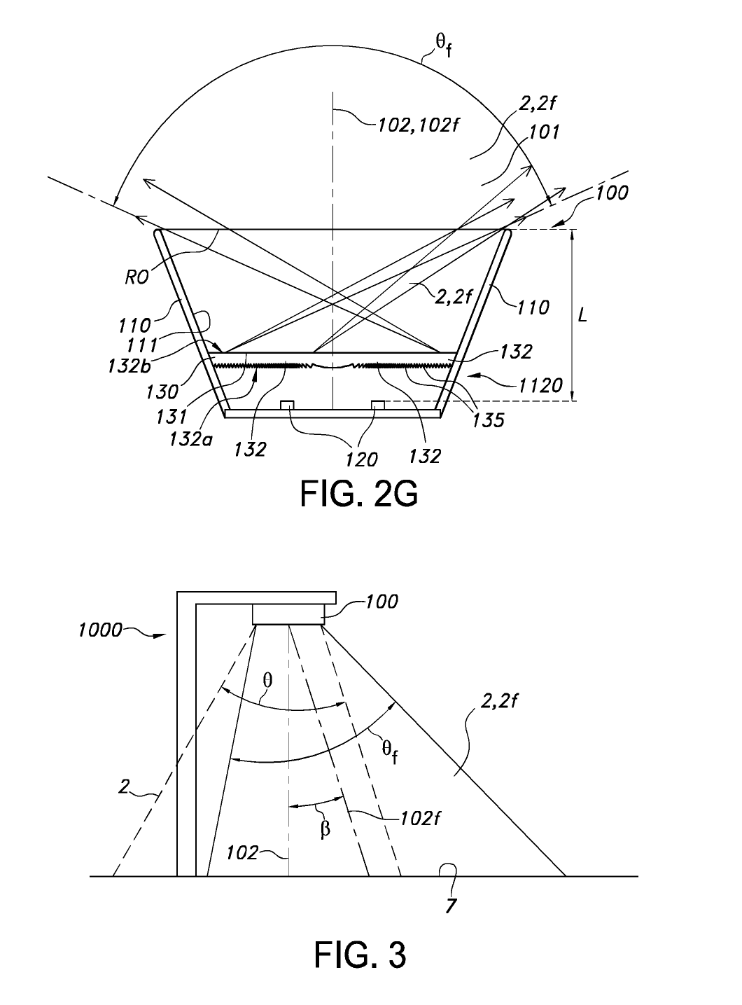

FIG. 2a schematically depicts an arrangement not part of the invention in which the optical plate 130, in fact two optical plates, arranged in the (larger) reflector 110, and configured to tilt the optical axis of the beam with opening angle θ by angle 13. For instance, prismatic structures may be applied as micro optical structures.

FIG. 2b schematically depicts another variant. Here the optical plate 130 has a perimeter substantially in contact with the reflector wall 111. In this embodiment, Fresnel lenses are used at the upstream face of the optical plate, which may have the function of collecting and collimating the light from the LEDs, and the prismatic structures, as micro optical structures 132, at the downstream face of the optical plate, may be used to tilt the optical axis of the beam. FIG. 2c schematically depicts a variant with only micro optical structures 132 at the upstream face of the optical plate 130, here mainly Fresnel lenses.

If desired, it may also be possible to tilt in more than one direction. A schematic embodiment, not part of the invention, is depicted in FIG. 2d. Note that of course more than two directions may be chosen. This can either be done by using different light sources and each giving a direction, and/or using the optical plate to create a plurality of directions. For instance, in FIG. 2b the downstream prismatic structures for the left part may be arranged in the opposite configuration of those at the right side (now these prismatic structures are all aligned with the long facet at the left side and the short facet at the right side). FIG. 2e schematically depict such embodiment, not part of the invention, when there are a plurality of reflector-light source units, wherein the reflector may be collimating optics 1110. Note that the left unit tilts in two directions whereas the right unit tilts in only one direction.

As indicated above, it is also possible to make the beam 2 broader than the reflector 110 allows, such as by adjusting the tilt angle per point. FIG. 2f1 schematically depicts 4 segments of Fresnel lenses together with TIR optical elements. Each segment redirects the light from the center of the corresponding LED under a certain angle θ_i, i=1,2,3,4. The size of the LEDs give the beam opening Δθ=60°/4. Together all the beams from each of the four segments make up the final target beam of θ=60° (see FIG. 2f2). The segments are made such and positioned such (=optimized) that the rays do not hit the existing reflector. Alternatively, one could place a single lens closer to the sources to create a 60°, but this may be impossible due to the presence of the reflector. In FIG. 2f2 of this figure, the final target beam is shown; in FIG. 2f3 of the figure, the final target beam made up of four beams provided by each segment is schematically depicted. FIG. 2g is substantially the same figure as FIG. 2f1. Here, a more general drawing is shown. A broad beam 2 with opening angle θ is provided, which opening angle is larger than could have been obtained without the additional optical plate 130. The optical plate 130 comprises a plurality of sections, indicated with reference 135.

The micro structures in these are only schematics. For instance, the dimensions, numbers, directions, may be different. Here, the drawings are schematical drawings (see also above). Further, also the reflectors are schematically drawn. Other shapes than schematically depicted are also possible.

FIG. 3 schematically depicts an application with a lamp 1000 comprising said lighting device 100. The dashed diverging lines indicate the initial beam with optical axis 102. This beam may, due to the construction of the lamp and the off-factory construction of the lighting device not be optimal for the specific application. Now, with the present invention the beam can be changed in properties, amongst others be tilted. The broad diverging solid lines indicate the beam as it can be in the final application, with optical axis 102f and an angle θ indicating the deviation from the original optical axis 102. Reference 7 indicates the surface, such as the surface of a road, etc.

1. A lighting device comprising a reflector with a reflector wall and a reflector opening and a light source configured to provide in the absence of an optical plate a beam of lighting device light with an original optical axis and an original opening angle (θ), wherein the lighting device comprises only one optical plate, wherein the optical plate comprises a light transmissive layer comprising micro optical structures, and wherein the lighting device including the optical plate is configured to provide said beam of lighting device light having one or more of (i) a final opening angle (θf) with θf>θ, and (ii) a final optical axis having a non-zero angle (β) with the original optical axis, the reflector widens from the light source to the reflector opening and has a length L, the optical plate being mounted within the reflector to the reflector wall in between 5% to 95% of the length L.

2. The lighting device according to claim 1, wherein the optical plate is configured to direct the beam of light away from the reflector wall downstream of the optical plate.

3. The lighting device according to claim 1, wherein the reflector wall has light reflective properties, and wherein the reflector wall comprises a discontinuity configured to host the optical plate.

4. The lighting device according to claim 1, wherein the optical plate is releasably attached to the reflector wall.

5. The lighting device according to claim 1, wherein the light source comprises a solid state light source.

6. The lighting device according to claim 1, wherein the optical plate comprises a foil comprising a plurality of micro optical structures selected of one or more of a Fresnel lens, a prismatic structure, and a facet.

7. The lighting device according to claim 1, wherein the optical plate comprises a plurality of micro optical structures at an upstream face or a plurality of micro optical structures at a downstream face.

8. The lighting device according to claim 1, wherein the optical plate comprises a plurality of micro optical structures at both an upstream face and a downstream face.

9. The lighting device according to claim 1, wherein the optical plate comprises a plurality of regions, wherein the lighting device including the optical plate with the plurality of regions is configured to provide a plurality of beams.

10. The lighting device according to claim 1, comprising a plurality of Fresnel lenses as micro optical structures.

11. The lighting device according to claim 1, wherein the micro optical structures have a dimension in the range of 0.001-5 mm.

12. A method of changing the optical properties of an existing lighting device, wherein the existing lighting device comprises a reflector with a reflector wall and a reflector opening and a light source, the reflector having a length L between the reflector opening and the light source and being configured to provide in the absence of an optical plate a beam of lighting device light with an original optical axis and an original opening angle (θ), the method comprising arranging only one optical plate to the reflector wall in the reflector in between 5% to 95% of length L downstream of the light source wherein the optical plate comprises a light transmissive layer comprising micro optical structures, and wherein the optical plate is configured to provide said beam of lighting device light with one or more of (i) a final opening angle (θf) with θf>θ, and (ii) a final optical axis (102f) having a non-zero angle (β) with the original optical axis.

13. The method according to claim 12, wherein the existing lighting device is in a pre-installed state or, wherein the existing lighting device is in an installed state.

14. The method according to claim 12, wherein the lighting device is comprised by a street lamp.

15. Use of only one optical plate comprising a light transmissive layer comprising micro optical structures in a reflector of an existing lighting device comprising said reflector and a light source for late-stage adaptation of optical properties of a beam of lighting device light generated by said lighting device during use.
